(19) United States
(12) Patent Application Publication
(10) Pub. No.: US 2019/0368146 A1
(43) Pub. Date: Dec. 5, 2019

(54) SALT SPREADER HEATING SYSTEM

(71) Applicants: BERT HOCHSPRUNG, Elburn, IL (US); KENT WILLIAMS, Elburn, IL (US)

(72) Inventors: BERT HOCHSPRUNG, Elburn, IL (US); KENT WILLIAMS, Elburn, IL (US)

(21) Appl. No.: 15/997,787

(22) Filed: Jun. 5, 2018

(51) Int. Cl. E01H 10/00; B60B 39/06; E01H 5/10; B60B 39/10

(52) U.S. Cl. CPC E01H 10/007; B60B 39/10; E01H 5/10; B60B 39/06

(57) ABSTRACT

The salt spreader heating system is a mobile apparatus. The salt spreader heating system: a) contains granulated material; b) heats the granulated material; and, c) distributes the granulated material over a surface. The salt spreader heating system comprises a silo, a pedestal, and a spreader. The pedestal supports the silo. The spreader attaches to the silo. The silo stores the granulated material. The silo heats the granulated material. The silo transports the granulated material to the spreader. The spreader distributes the granulated material over a surface area. The salt spreader heating system is configured for use with a truck. The truck is further defined with a bed and a radiator system. The pedestal raises the silo over the bed of the truck. The radiator system cools the engine of the truck. The silo uses the heat transferred from the engine to the radiator system to heat the granulated material.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of the construction of roads including street cleaning, more specifically, a mobile apparatus for spreading granular material on a road.

### SUMMARY OF INVENTION

The salt spreader heating system is a mobile apparatus. The salt spreader heating system: a) contains a granulated material; b) heats the granulated material; and, c) distributes the granulated material over a surface. The salt spreader heating system comprises a silo, a pedestal, and a spreader. The silo mounts in the pedestal. The spreader mounts on the silo. The silo stores the granulated material. The silo heats the granulated material. The silo transports the granulated material to the spreader. The spreader distributes the granulated material over a surface area. The salt spreader heating system is configured for use with a vehicle. The vehicle is a truck. The vehicle is further defined with a bed and a radiator system. The pedestal raises the silo over the bed of the vehicle. The radiator system cools the engine of the vehicle. The silo uses the heat transferred from the engine to the radiator system to heat the granulated material.

These together with additional objects, features and advantages of the salt spreader heating system will be readily apparent to those of ordinary skill in the art upon reading the following detailed description of the presently preferred, but nonetheless illustrative, embodiments when taken in conjunction with the accompanying drawings.

In this respect, before explaining the current embodiments of the salt spreader heating system in detail, it is to be understood that the salt spreader heating system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the salt spreader heating system.

It is therefore important that the claims be regarded as including such equivalent construction insofar as they do not depart from the spirit and scope of the salt spreader heating system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an anterior view of an embodiment of the disclosure.

FIG. 2 is a side view of an embodiment of the disclosure.

FIG. 3 is a posterior view of an embodiment of the disclosure.

FIG. 4 is a detail view of an embodiment of the disclosure.

FIG. 5 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

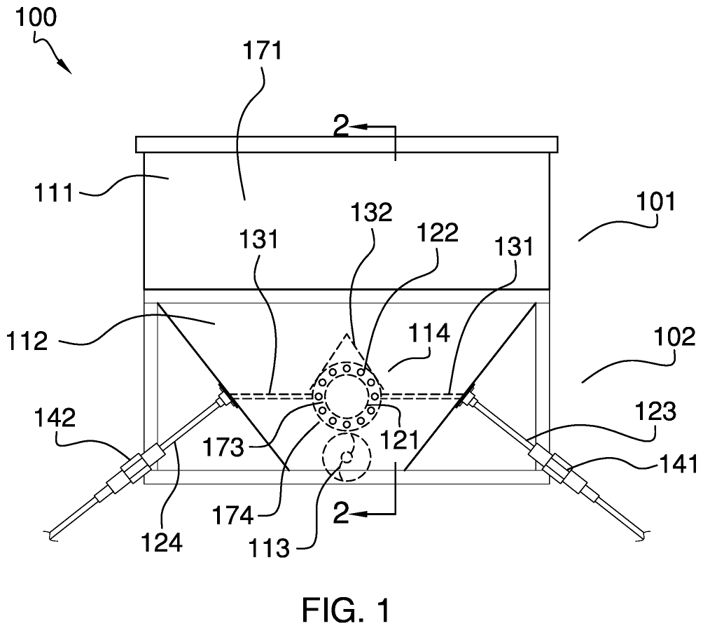

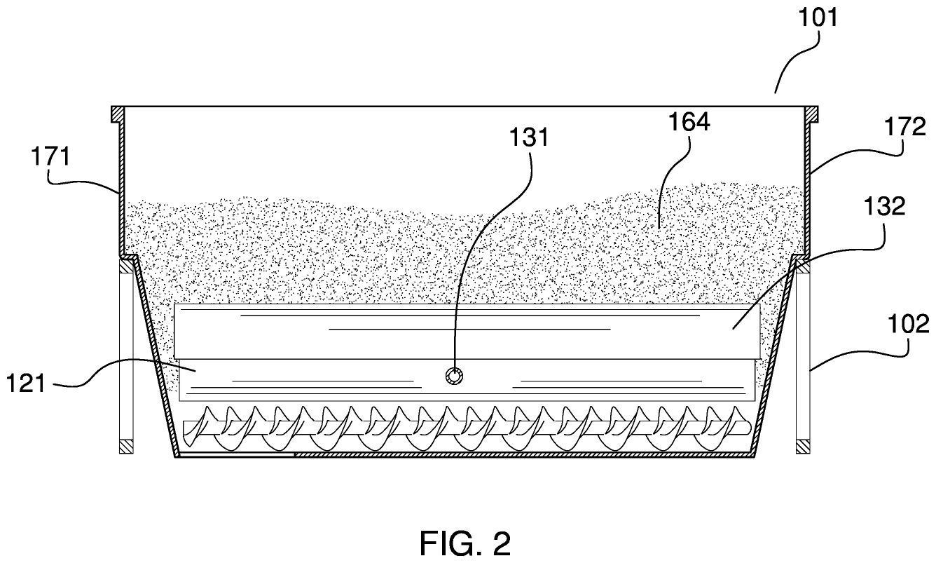

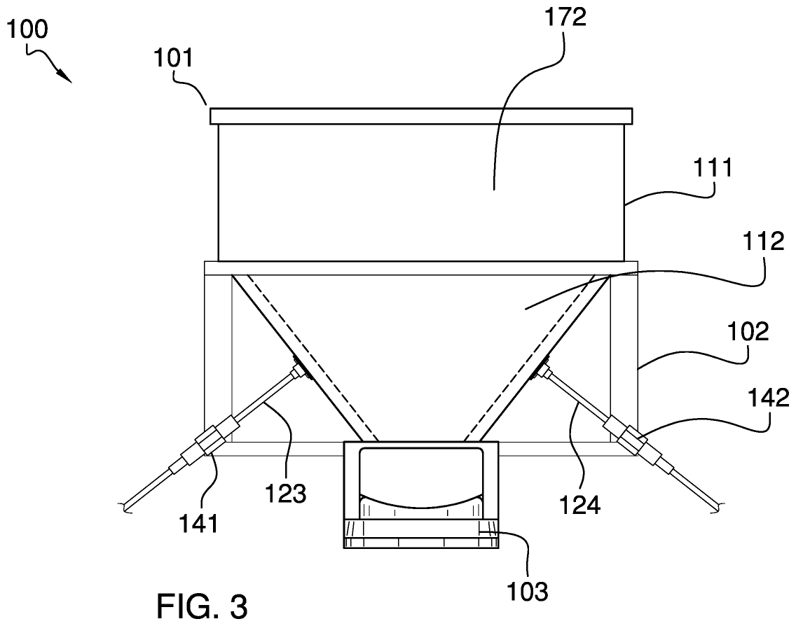

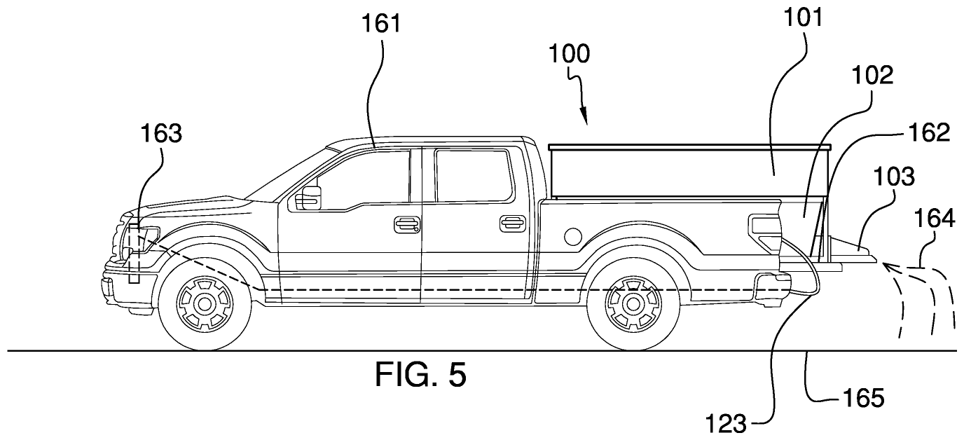

Detailed reference will now be made to one or more potential embodiments of the disclosure, which are illustrated in FIGS. 1 through 5.

The salt spreader heating system 100 (hereinafter invention) is a mobile apparatus. The invention 100: a) contains a granulated material 164; b) heats the granulated material 164; and, c) distributes the granulated material 164 over a surface 165. The invention 100 comprises a silo 101, a pedestal 102, and a spreader 103. The silo 101 mounts in the pedestal 102. The spreader 103 attaches to the silo 101. The silo 101 stores the granulated material 164. The silo 101 heats the granulated material 164. The silo 101 transports the granulated material 164 to the spreader 103. The spreader 103 distributes the granulated material 164 over a surface 165 area.

The invention 100 is configured for use with a vehicle 161. The vehicle 161 is a truck. The vehicle 161 is further defined with a bed 162 and a radiator system 163. The pedestal 102 raises the silo 101 over the bed 162 of the vehicle 161. The radiator system 163 cools the engine of the vehicle 161. The silo 101 uses the heat transferred from the engine to the radiator system 163 to heat the granulated material 164. In the first potential embodiment of the disclosure, the granulated material 164 is an alkali metal salt such as sodium chloride or potassium chloride.

The silo 101 is a hollow rectilinear block structure. The silo 101 forms the contained space that stores the granulated material 164. The silo 101 comprises a bin 111, a hopper 112, an auger 113, and a heat exchanger 114. The hopper 112 contains the auger 113 and the heat exchanger 114. The silo 101 is further defined with an anterior face 171 and a posterior face 172. The anterior face 171 is the face of the silo 101 that leads the invention 100 into the primary sense of direction of the vehicle 161. The posterior face 172 is the face of the silo 101 that is distal from the anterior face 171.

The bin 111 is a hollow rectangular block structure. The inferior face and the superior face of the bin 111 are open. The bin 111 mounts on the hopper 112 such that the storage capacity of the hopper 112 extends in the superior direction.

The hopper 112 is a hollow truncated pyramid structure that forms a trough. The hopper 112 is an inverted structure such that the base of the truncated pyramid forms the superior face of the hopper 112. The inverted pyramidal structure of the hopper 112 routes the granulated material 164 to the auger 113 as the granulated material 164 is dispensed by the invention 100. The base of the hopper 112 is open. The bin 111 attaches to the base of the hopper 112 such that granulated material 164 stored in the bin 111 will flow into the hopper 112 as space created by the dispersion of the granulated material 164 is formed in the hopper 112.

The auger 113 is a mechanical structure that transports the granulated material 164 stored in the silo 101 to the spreader 103. The auger 113 is a rotating device. The auger 113 is a simple machine based on a screw structure. The screw structure of the auger 113 moves the granulated material 164 within the hopper 112 when the auger 113 is rotated. Methods to rotate the auger 113 are well-known and documented in the mechanical arts. The auger 113 drives the granulated material 164 stored in the hopper 112 towards the spreader 103 for distribution.

The heat exchanger 114 is a heat exchange device that heats the granulated material 164 before the granulated material 164 is distributed by the spreader 103. The heat exchanger 114 heats the granulated material 164 such that the granulated material 164 will more readily dissolve in frozen or partially frozen water found on the surface 165 area covered by the spreader 103. The heat exchanger 114 is a heat exchange device. The heat exchanger 114 cycles a fluid medium 166 from the radiator system 163 through the granulated material 164 stored in the hopper 112 such that the excess engine heat removed by the granulated material 164 heats the granulated material 164. The heat exchanger 114 comprises a raised prism 121, a heat transfer coil 122, an intake line 123, and a discharge line 124.

The raised prism 121 is an inert prism-shaped structure. The ends of the raised prism 121 attach to the anterior face 171 and the posterior face 172 of the silo 101 such that the center axis of the raised prism 121 aligns with the primary sense of direction of the vehicle 161. The raised prism 121 is further defined with an inner lateral face 173 and an outer lateral face 174.

The lateral face of the raised prism 121 is formed with an inner lateral face 173 and an outer lateral face 174 that form the inner perimeter and the outer perimeter of lateral face of the prism structure of the raised prism 121. The inner lateral face 173 of the raised prism 121 is formed from an insulating material. The outer lateral face 174 is formed from a heat conducting material such that heat delivered to the heat exchanger 114 by the radiator system 163 radiates preferentially away from the center axis of the prism structure of the raised prism 121. The raised prism 121 further comprises reinforcing struts 131 and a diverting cap 132.

The reinforcing struts 131 are rigid structures that attach the lateral face of the raised prism 121 to the left and right sides of the hopper 112. The reinforcing struts 131 provide structural support for the raised prism 121. The intake line 123 and the discharge line 124 mount on the reinforcing struts 131.

The diverting cap 132 is a triangular prism structure that attaches to the superior side of the lateral face of the raised prism 121. The diverting cap 132 routes the granulated material 164 around the raised prism 121 such that the granulated material 164 will not accumulate on top of the raised prism 121.

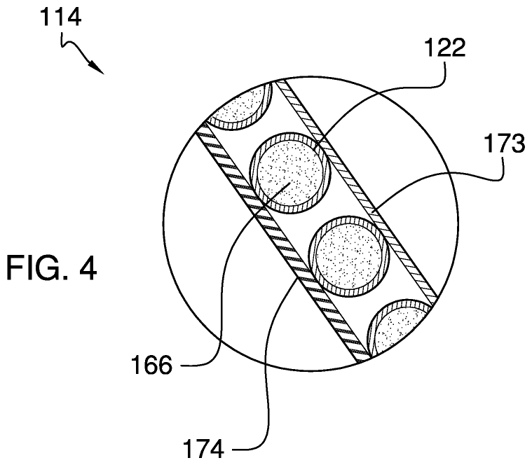

The heat transfer coil 122 is a tubular structure. As shown most clearly in FIG. 4, the heat transfer coil 122 is a coil that wraps around the prism structure of the raised prism 121. The heat transfer coil 122 is positioned between the inner lateral face 173 and the outer lateral face 174 of the raised prism 121. The heat transfer coil 122 transports a fluid medium 166 drawn from the radiator system 163 through the granulated material 164 stored within the hopper 112 such that the heat carried by the fluid medium 166 is transferred to the granulated material 164 through the outer lateral face 174. The heat transfer coil 122 forms a portion of the fluid circuit such that the fluid medium 166 returns to the radiator system 163 after passing through the heat transfer coil 122.

The intake line 123 is a hose that receives the fluid medium 166 from the radiator system 163 and transports the fluid medium 166 to the heat transfer coil 122. The intake line 123 further comprises an intake quick release fitting 141. The intake quick release fitting 141 is a commercially available quick release fitting that attaches the intake line 123 to the radiator system 163.

The discharge line 124 is a hose that receives the fluid medium 166 from the heat transfer coil 122 and returns the fluid medium 166 to the radiator system 163. The discharge line 124 further comprises a discharge quick release fitting 142. The discharge quick release fitting 142 is a commercially available quick release fitting that attaches the discharge line 124 to the radiator system 163. The pedestal 102 is a framework. The pedestal 102 supports the silo 101 such that the load path of the load of the silo 101 transfers to the bed 162 of the vehicle 161 through a load path created by the pedestal 102. The pedestal 102 is a hollow rectangular block structure. The pedestal 102 is an openwork structure. The pedestal 102 suspends the silo 101 above the bed 162 of the vehicle 161. The superior face of the pedestal 102 is open such that the hopper 112 of the silo 101 inserts through the superior face into the pedestal 102. The span of the perimeter of the bin 111 is greater than the span of the perimeter of the pedestal 102 such that the bin 111 rests on the pedestal 102 to suspend the hopper 112 above the bed 162 of the vehicle 161.

The spreader 103 is a commercially available device. The spreader 103 is configured to receive granulated material 164 and to distribute the granulated material 164 over a surface 165 area. The spreader 103 is configured to operate while the vehicle 161 is moving along the primary sense of direction. The spreader 103 spreads the granulated material 164 from the posterior face 172 of the silo 101.

The following definitions and directional references were used in this disclosure:

Anterior: As used in this disclosure, anterior is a term that is used to refer to the front side or direction of a structure. When comparing two objects, the anterior object is the object that is closer to the front of the structure.

Auger: As used in this disclosure, an auger is a cylinder or a cone that is formed with an exterior screw thread. One purpose of an auger is to use the rotation of the auger to move an object through a linear distance through a pipe.

Base: As used in this disclosure, a base is the surface of a pyramid that is distal from: a) the apex of a pyramid; or, b) the truncated surface of a truncated pyramid.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Coil: As used in this disclosure, a coil is a structure that has the shape of a helix, volute, or a spiral. The structure of the coil is often a cord, wire, hose, or tube.

Cord: As used in this disclosure, a cord is a long, thin, flexible, and prism shaped string, line, rope, or wire. Cords are made from yarns, piles, or strands of material that are braided or twisted together or from a monofilament (such as fishing line). Cords have tensile strength but are too flexible to provide compressive strength and are not suitable for use in pushing objects. String, line, cable, and rope are synonyms for cord.

Correspond: As used in this disclosure, the term correspond is used as a comparison between two or more objects wherein one or more properties shared by the two or more objects match, agree, or align within acceptable manufacturing tolerances.

Framework: As used in this disclosure, a framework refers to the substructure of an object that carries the load path of the object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. Always use Correspond and One to One

Granule: As used in this disclosure, refers to an individual particle selected from a plurality of particles that represents a material. A material formed from a plurality of granules is said to be a granular or granulated material. The verb granulate refers to the formation of granules to create a granular material. A granular material often exhibits fluidic behaviors including flow.

Helix: As used in this disclosure, a helix is the three-dimensional structure that would be formed by a wire that is wound uniformly around the surface of a cylinder or a cone. If the wire is wrapped around a cylinder the helix is called a cylindrical helix. If the wire is wrapped around a cone, the helix is called a conical helix. A synonym for conical helix would be a volute.

Hose: As used in this disclosure, a hose is a flexible hollow cylindrical device used for transporting liquids and gases. When referring to a hose in this disclosure, the terms inner diameter and outer diameter are used as they would be used by those skilled in the plumbing arts.

Inert Structure: As used in this disclosure, an inert structure is a physical structure that has no moving parts. An inert structure can be a component in a larger, moving structure.

Inferior: As used in this disclosure, the term inferior refers to an edge or surface of an object that would commonly be referred to as the bottom of the object.

Inner Perimeter and Outer Perimeter: As used in this disclosure, the inner perimeter and the outer perimeter refer to two geometrically similar structures of curved object. The inner perimeter refers to the geometrically similar structure with the shorter span. The outer perimeter refers to the geometrically similar structure with the greater span.

Insulating Material: As used in this disclosure, an insulating material is a structure that inhibits, and ideally prevents, the transfer of heat through the insulating material. Insulating materials may also be used to inhibit or prevent the transfer of sound or the conduction of electricity through the insulating material. Methods to form insulating materials include, but are not limited to: 1) the use of materials with low thermal conductivity; and, 2) the use of a structural design that places a vacuum within the insulating material within the anticipated transfer path of the heat, sound, or electric current flow.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load Path: As used in this disclosure, a load path refers to a chain of one or more structures that transfers a load generated by a raised structure or object to a foundation, supporting surface, or the earth.

N-gon: As used in this disclosure, an N-gon is a regular polygon with N sides wherein N is a positive integer number greater than 2.

One to One: When used in this disclosure, a one to one relationship means that a first element selected from a first set is in some manner connected to only one element of a second set. A one to one correspondence means that the one to one relationship exists both from the first set the second set and from the second set to the first set. A one to one fashion means that the one to one relationship exists in only one direction.

Openwork: As used in this disclosure, the term open work is used to describe a structure, often a surface, which is formed with openings that allow for visibility and airflow through the structure. Wrought work and meshes are forms of openwork.

Pedestal: As used in this disclosure, a pedestal is an intermediary load bearing structure that that transfers a load path between a supporting surface and an object, structure, or load.

Perimeter: As used in this disclosure, a perimeter is one or more curved or straight lines that bounds an enclosed area on a plane or surface. The perimeter of a circle is commonly referred to as a circumference.

Pickup Truck: As used in this disclosure, a pickup truck is a vehicle having an enclosed cab and an open body comprising low sides and a tailgate that is powered by an internal combustion engine. A pickup truck is further defined with a bed, a tailgate, a left sidewall, a right sidewall, and an end wall.

Posterior: As used in this disclosure, posterior is a term that is used to refer to the side of an object that is distal or in the opposite direction of the anterior side. When comparing two items, the posterior item is the item that is distal from the front of the object.

Primary Sense of Direction: As used in this disclosure, the primary sense of direction of an object refers to a vector that: 1) passes through the center of the object; and, 2) is parallel to the direction of travel when the anterior surface(s) of the object are leading the object into the direction of travel. This definition intends to align with what people would normally call the forward direction of an object.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Pyramid: As used in this disclosure, a pyramid is a three-dimensional shape that comprises a base formed in the shape of an N-gon (wherein N is an integer) with N triangular faces that rise from the base to converge at a point above the base. If the point where the N faces meet is positioned such that a line drawn from the point where the N faces meet to the center of the N-gon base is perpendicular to the N-gon base, the pyramid is referred to as a right pyramid. Pyramids can be further formed with circular or elliptical bases which are commonly referred to as cone or an elliptical pyramid respectively. A pyramid is defined with a base, an apex, and a lateral face. The base is the N-gon shaped base described above. The apex is the convergence point described above. The lateral face is formed from the N triangular faces described above.

Quick Connect Fitting: As used in this disclosure, a quick connect fitting is a coupling that is used in fluid flow applications to quickly connect or disconnect two lines or two objects through which fluids will flow. Connections or disconnections are intended to be done by hand without the use of tools. Quick connect fittings readily and commercially available and methods for their selection and use well known and documented in the mechanical, chemical, and plumbing arts.

Rectangular Block: As used in this disclosure, a rectangular block refers to a three-dimensional structure comprising six rectangular surfaces formed at right angles. Within this disclosure, a rectangular block may further comprise rounded edges and corners.

Rectilinear: As used in this disclosure, rectilinear is an adjective that is used to describe an object that: 1) moves in a straight line or lines; 2) consists of a straight line or lines; 3) is bounded by a straight line or lines; or, 4) is otherwise characterized by a straight line or lines.

Rectilinear Block: As used in this disclosure, a rectilinear block refers to a three-dimensional structure comprising a plurality of rectangular surfaces. Rectilinear blocks are similar to rectangular blocks and are often used to create a structure with a reduced interior volume relative to a rectangular block. Within this disclosure, a rectilinear block may further comprise rounded edges and corners.

Salt: As used in this disclosure, a salt means an ionic compound that further comprises at least one atom of a metallic element or compound and one atom of a non-metallic element or compound. When dissolved in water, the ionic compound releases the metallic element and the non-metallic element into the water as ions. In this disclosure, a metallic element is assumed to include the alkali metals and the alkali earth metals. Alternatively, and equivalently, a metallic element may be assumed to be any element on the periodic table that is to the left of the metalloids.

Silo: As used in this disclosure, a silo is a containment structure used to store and distribute a granulated material.

Simple Machine: As used in this disclosure, a simple machine refers to a device that consists of a mechanism selected from the group consisting of: 1) an inclined plane, 2) a lever; 3) a pivot, 4) a pulley, 5) a screw, 6) a spring, 7) a wedge, and 8) a wheel (including axles). A compound machine is a device that consists of a plurality of mechanisms selected from the group consisting of the simple machine.

Spiral: As used in this disclosure, a spiral describes a locus of points within a plane moving around a fixed center wherein the locus of points moves monotonically increasing manner away from the center.

Spreader: As used in this disclosure, a spreader is a device that evenly distributes granulated matter over a surface.

Superior: As used in this disclosure, the term superior refers to an edge or surface of an object that would commonly be referred to as the top of the object.

Trough: As used in this disclosure, a trough is an open receptacle used to: 1) store a fluid in a manner accessible to an animal; or, 2) to physically determine and limit the flow path of a fluid. The rain gutter commonly seen on a building is an example of a trough.

Truncated Pyramid: As used in this disclosure, a truncated pyramid is a frustum that remains when the apex of a pyramid is truncated by a plane that is parallel to the base of the pyramid.

Tube: As used in this disclosure, a tube is a hollow prism shaped device formed with two open ends. The tube is used for transporting liquids and gases. The line that connects the center of the first congruent face of the prism to the center of the second congruent face of the prism is referred to as the center axis of the tube or the centerline of the tube. When two tubes share the same centerline they are said to be aligned. When the centerlines of two tubes are perpendicular to each other, the tubes are said to be perpendicular to each other. In this disclosure, the terms inner dimensions of a tube and outer dimensions of a tube are used as they would be used by those skilled in the plumbing arts.

Vehicle: As used in this disclosure, a vehicle is a motorized device that is used for transporting passengers, goods, or equipment. The term motorized vehicle refers to a vehicle can move under power provided by an electric motor or an internal combustion engine.

Volute: As used in this disclosure, a volute is the three-dimensional structure that would be formed by a wire that is wound uniformly around the surface of a cone. A synonym for volute would be a conical helix.

Wire: As used in this disclosure, a wire is a structure with the general appearance of a cord or strand that is formed from an electrically conductive metal.

The directional references used in this disclosure correspond to the directional references from the perspective of the vehicle. The anterior or front side is the side of the vehicle proximal to the normal direction of travel. The posterior or rear side is the side of the vehicle that is distal from the anterior side. The inferior side is the side of the vehicle that is closest to the ground. The superior side of the vehicle is the side of the vehicle that is distal to the inferior side. The left side is to the left side of a person facing the direction of the primary sense of direction of the vehicle. The right side is the side of the vehicle that is distal from the left side. The terms distal and medial refer to a hypothetical line that is drawn from the center point of the front axle to the center point of the rear axle. When comparing a first object to a second object, the first object is said to be the distal object if the span of the perpendicular distance from the first object the hypothetical line is greater than the span of the perpendicular distance from the second object to the hypothetical line. A first object is said to be the medial object if the span of the perpendicular distance from the first object the hypothetical line is less than the span of the perpendicular distance from the second object to the hypothetical line.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A mobile apparatus comprising:
a silo, a pedestal, and a spreader;
wherein the silo mounts in the pedestal;
wherein the spreader attaches to the silo;
wherein the mobile apparatus contains a granulated material;
wherein the mobile apparatus heats the granulated material;
wherein the mobile apparatus distributes the granulated material over a surface;
wherein the silo stores the granulated material;
wherein the silo heats the granulated material;
wherein the silo transports the granulated material to the spreader;
wherein the spreader distributes the granulated material over a surface area.

2. The mobile apparatus according to claim 1
wherein the mobile apparatus is configured for use with a vehicle;
wherein the vehicle is further defined with a bed and a radiator system;
wherein the pedestal raises the silo over the bed of the vehicle;
wherein the radiator system cools the engine of the vehicle;
wherein the silo uses the heat transferred from the engine to the radiator system to heat the granulated material.

3. The mobile apparatus according to claim 2 wherein in the first potential embodiment of the disclosure, the granulated material is an alkali metal salt.

4. The mobile apparatus according to claim 3
wherein the silo is a hollow rectilinear block structure;
wherein the silo forms a contained space that stores the granulated material;
wherein the silo is further defined with an anterior face and a posterior face.

5. The mobile apparatus according to claim 4
wherein the pedestal is a framework;
wherein the pedestal is a hollow rectangular block structure;
wherein the pedestal is an openwork structure;
wherein the pedestal suspends the silo above the bed of the vehicle;
wherein the superior face of the pedestal is open such that the hopper of the silo inserts through the superior face into the pedestal.

6. The mobile apparatus according to claim 5
wherein the spreader receives granulated material
wherein the spreader distributes the granulated material over a surface area;
wherein the spreader is configured to operate while the vehicle is moving along the primary sense of direction;
wherein the spreader spreads the granulated material from the posterior face of the silo.

7. The mobile apparatus according to claim 6
wherein the silo comprises a bin, a hopper, an auger, and a heat exchanger;
wherein the bin attaches to the hopper;
wherein the hopper contains the auger and the heat exchanger.

8. The mobile apparatus according to claim 7
wherein the bin is a hollow rectangular block structure;
wherein the inferior face and the superior face of the bin are open;
wherein the bin mounts on the hopper such that the storage capacity of the hopper extends in the superior direction.

9. The mobile apparatus according to claim 8
wherein the hopper is a hollow truncated pyramid structure;
wherein the hopper is an inverted structure such that the base of the truncated pyramid forms the superior face of the hopper;
wherein the inverted pyramidal structure of the hopper that routes the granulated material to the auger.

10. The mobile apparatus according to claim 9
wherein the base of the hopper is open;
wherein the bin attaches to the base of the hopper such that granulated material stored in the bin will flow into the hopper.

11. The mobile apparatus according to claim 10
wherein the auger is a rotating device;
wherein the auger is a mechanical structure;
wherein the auger transports the granulated material to the spreader.

12. The mobile apparatus according to claim 11
wherein the heat exchanger is a heat exchange device;
wherein the heat exchanger heats the granulated material;
wherein the heat exchanger transports a fluid medium from the radiator system.

13. The mobile apparatus according to claim 12
wherein the heat exchanger comprises a raised prism, a heat transfer coil, an intake line, and a discharge line;
wherein the heat transfer coil attaches to the raised prism;
wherein the intake line and the discharge line attach to the radiator system.

14. The mobile apparatus according to claim 13
wherein the raised prism is an inert prism-shaped structure;
wherein the ends of the raised prism attach to the anterior face and the posterior face of the silo such that the center axis of the raised prism aligns with the primary sense of direction of the vehicle;
wherein the lateral face of the raised prism is further defined with an inner lateral face and an outer lateral face;
wherein the inner lateral face of the raised prism is formed from an insulating material;
wherein the outer lateral face is formed from a heat conducting material.

15. The mobile apparatus according to claim 14
wherein the heat transfer coil is a tubular structure;
wherein the heat transfer coil wraps around the prism structure of the raised prism;
wherein the heat transfer coil is positioned between the inner lateral face and the outer lateral face of the raised prism.

16. The mobile apparatus according to claim 15 wherein the heat transfer coil transports the fluid medium drawn from the radiator system through the granulated material stored within the hopper such that the heat carried by the fluid medium transfers to the granulated material through the outer lateral face.

17. The mobile apparatus according to claim 16
wherein the intake line is a hose that receives the fluid medium from the radiator system and transports the fluid medium to the heat transfer coil;
wherein the discharge line is a hose that receives the fluid medium from the heat transfer coil and returns the fluid medium to the radiator system.

18. The mobile apparatus according to claim 17
wherein the intake line further comprises an intake quick release fitting;
wherein the discharge line further comprises a discharge quick release fitting;
wherein the intake quick release fitting attaches the intake line to the radiator system;
wherein the discharge quick release fitting attaches the discharge line to the radiator system.

19. The mobile apparatus according to claim 18
wherein the raised prism further comprises reinforcing struts and a diverting cap;
wherein the reinforcing struts are rigid structures;
wherein the reinforcing struts attach the lateral face of the raised prism to the hopper;
wherein the intake line and the discharge line mount on the reinforcing struts.

20. The mobile apparatus according to claim 19
wherein the raised prism further comprises a diverting cap;
wherein the diverting cap is a triangular prism structure that attaches to the superior side of the lateral face of the raised prism.
